(19) United States
(12) Patent Application Publication
(10) Pub. No.: US 2017/0361684 A1
(43) Pub. Date: Dec. 21, 2017

(54) USE OF A FILTER ELEMENT HAVING A FINE POROUS COATING

(71) Applicant: Carl Freudenberg KG, Weinheim (DE)

(72) Inventors: Thomas Stoeßer, Viernheim (DE); Maik Sieh, Sandhausen (DE); Renate Tapper, Bensheim (DE)

(21) Appl. No.: 15/693,884

(22) Filed: Sep. 1, 2017

Related U.S. Application Data
(62) Division of application No. 14/521,758, filed on Oct. 23, 2014.

(30) Foreign Application Priority Data
Oct. 28, 2013 (DE) 10 2013 017 758.8

(51) Int. Cl. B60H 3/06; B01D 46/52; B01D 46/24; B01D 46/54; B01D 46/00

(52) U.S. Cl. CPC B60H 3/0658; B60H 3/0633; B01D 46/546; B01D 46/0057; B01D 46/2403; B01D 46/521

(57) ABSTRACT

A filter element for the filtration of the incoming cabin air of vehicles is disclosed. The filter element can be readily regenerated and reused in a dust-loaded environment. The filer element includes a main body formed from at least one filter medium. The main body has an inflow side and an outflow side. The filter element is used as a regenerable filter element for the filtration of the incoming cabin air in a vehicle which is subjected to elevated dust loading. A coating of nanofibers and/or a diaphragm is arranged on the inflow side of the main body.

### CROSS-REFERENCE TO RELATED APPLICATION

This patent application is a divisional patent application of copending U.S. patent application Ser. No. 14/521,758 filed Oct. 23, 2014 which claims priority to German Patent Application No. DE 10 2013 017 758.8, filed on Oct. 28, 2013, the entire disclosures of which are hereby incorporated herein by reference.

### FIELD OF THE INVENTION

The invention relates to the use of a filter element used as a regenerable filter element for filtration of incoming cabin air in a vehicle which is subjected to elevated dust loading, a coating of nanofibers and/or a diaphragm being arranged on an inflow side of a main body of the filter element.

### BACKGROUND OF THE INVENTION

Filter elements which store dust in a main body comprising a filter medium are known from the prior art. Filter elements of this type are also called depth filters.

During the operation of a storage filter element of this type, dust accumulates in the filter medium. As a result of the accumulation, the throughflow resistance of the filter element is increased irreversibly.

The use of filter elements which utilize depth filtration is therefore not always technically appropriate in fields of application with great dust loading.

As soon as filter elements which utilize the principle of depth filtration are used in vehicles which are subjected to elevated dust loading, the filter elements can become clogged with dust very rapidly. Filter elements of this type have to be replaced and disposed of after a relatively short operating duration.

### SUMMARY OF THE INVENTION

The invention is therefore based on the object of using a filter element for the filtration of the incoming cabin air of vehicles of this type, which filter element can be readily regenerated and reused in a dust-loaded environment.

The present invention achieves the abovementioned object.

According to the invention, it has been recognized that a fine porous coating of nanofibers or a diaphragm reduces the penetration of dust or other particles into the filter medium or filter media of the main body of a filter element. A steady-state operating state of the filter element is surprisingly produced rapidly in the case of the use of a filter element of this type in vehicles, the throughflow resistance after a short use duration being lower than in the case of storage filter elements.

According to the invention, storage filter elements, as customary in the motor vehicle industry, are therefore not used for the filtration of the incoming cabin air. According to the invention, the technical preconception has been overcome here that a filter element with a fine porous coating or with a diaphragm is actually unsuitable for the filtration of the incoming cabin air, because this would overload the fan. This is linked to the fact that a filter element of this type should exhibit a relatively high throughflow resistance compared with a filter element for depth filtration.

However, a dust cake can be removed, for example by way of flushing air or vibrations, from the surface of the filter element which is used according to the invention. According to the invention, the above-described filter element is therefore used as a regenerable filter element for the filtration of the incoming cabin air in a vehicle which is subjected to elevated dust loading. Elevated dust loading is understood to mean the presence of a dust concentration of at least 2 mg/m³, preferably of at least 5 mg/m³, or preferably of at least 500 mg/m³.

Vehicles having elevated dust loading are frequently used in construction, in a mine, or in agriculture, for example. According to the invention, filter elements which utilize depth filtration are not used, since they become rapidly clogged with dust in the case of an elevated dust concentration. On account of the coating or diaphragm of the main body, the filter element can be cleaned readily by way of a jet of compressed air, by way of mechanical shaking, or the customary operational vibration of a vehicle. To this extent, a filter element which can be readily regenerated and reused in a dust-loaded environment is used for the filtration of the incoming cabin air of the abovementioned vehicles.

As a consequence, the object which was mentioned at the outset is achieved.

There is elevated dust loading if there is a dust concentration of at least 2 mg/m³, preferably of at least 5 mg/m³, and particularly preferably of at least 500 mg/m³, with an upper limit of 5 g/m³.

The vehicle might be selected from the group comprising lorries, construction machines, compactors, tracked vehicles, road mills, bulldozers, dumpers, tracked backhoes, graders, diggers, excavators, cranes, harvesters, agricultural machines, combine harvesters, chippers, tractors, self-propelled sprayers, and forestry vehicles and the like, for example. These vehicles move in an environment, in which there is a particularly high dust concentration. Environments of this type are found in construction, in mines, or in agriculture.

The mean diameter of the nanofibers which are described herein might be less than 1 μm, preferably less than 500 nm, and particularly preferably less than 100 nm. The diameter is selected depending on the size of the particles to be filtered and on the desired filter efficiency.

The filter media which are used preferably meet the requirements of EN 15695-2, namely the requirements of a dust filter element and, with a corresponding configuration of the coating, of an aerosol filter element.

The filter media are particularly preferably configured as nonwovens.

The filter medium might be pleated. The main body including the coating or the diaphragm might be pleated. Folding or pleating increases the effective filter area per unit of volume of the filter element.

The filter medium might be grooved. The grooving of the main body and/or the coating or the diaphragm forms channels in the filter element. As a result, different flow velocities which remove a dust cake from the depth of a fold are produced during the regeneration process. Even fibrous and moist dust can surprisingly be removed from the depth of a fold by way of this inhomogeneous outflow. This effect makes the filter element which is described herein suitable for the filtration of the incoming cabin air in vehicles which are subjected to particularly pronounced dust loading or dust concentration.

The filter element might be configured as a filter tube. The filter tube can be used in a pleated or non-pleated state. A filter tube can be cleaned readily by way of jets of compressed air to free the filter tube from dust.

The filter element might be configured as a filter cartridge. The filter cartridge can be configured as what is known as a star filter. A filter cartridge can be used in a manner which saves installation space. Furthermore, a filter cartridge can be cleaned readily. A filter cartridge makes a relatively large amount of filter area per unit of installation space available.

The main body might consist of a first layer and a second layer which have bicomponent fibres. Bicomponent fibres can be melted readily, in order to enter into an integrally joined connection with other fibres. An additional binder is not necessary, with the result that high material consistency can be realized.

The first and/or the second layer might be bonded thermally. As a result, the filter element is given an increased stability against bending or twisting.

The nanofibers might be produced from polyamide or from polyvinyl difluoride. Robust and mechanically resistant nanofibers can be produced from polyamide. Hydrophobic nanofibers can be produced from polyvinyl difluoride.

The diaphragm might be composed of polytetrafluoroethylene. This material is hydrophobic. The diaphragm is a fine porous diaphragm.

### BRIEF DESCRIPTION OF THE DRAWINGS

The above and other objects, features and other advantages of the present invention will be more clearly understood from the following detailed description taken in conjunction with the accompanying drawings, in which:

FIG. 1A shows a sectional illustration of one embodiment of a filter element;

FIG. 1B shows a sectional illustration of another embodiment of a filter element;

FIG. 2 shows a perspective view of a filter element which is provided with pleating and grooving;

FIG. 3 shows a filter tube; and

FIG. 4 shows a filter cartridge.

### DETAILED DESCRIPTION OF EXEMPLARY EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner.

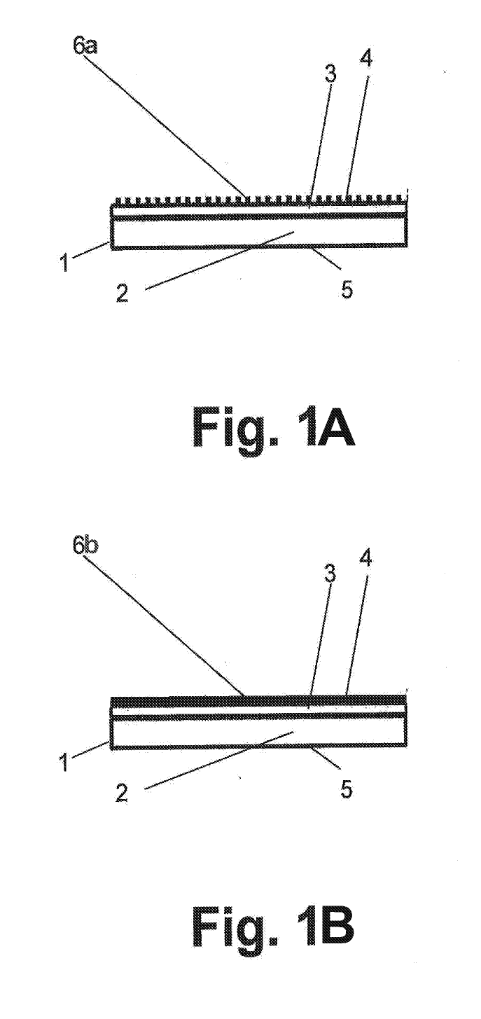

FIGS. 1A and 1B show embodiments of a filter element, comprising a main body 1, the main body 1 can be formed from a first layer 2 of a filter medium and a second layer 3 of a filter medium. The main body 1 has an inflow side 4 and an outflow side 5. A coating 6a or a diaphragm 6b is arranged on the inflow side 4 of the main body 1.

The coating 6a is a fine porous coating formed of nanofibers. The mean diameter of the nanofibers which are described herein is typically smaller than 200 nm. The diaphragm 6b might be composed of polytetrafluoroethylene. This material is hydrophobic. The diaphragm 6b is a fine porous diaphragm.

The main body 1 includes the first layer 2 and the second layer 3 which have bicomponent fibres. The first layer 2 in the embodiment shown has a weight per unit area of 110 to 300 g/m² and comprises bicomponent fibres from two polyester types.

The first layer 2 and the second layer 3 are bonded thermally. The second layer 3 in the embodiment shown has a weight per unit area of 40 g/m² and comprises bicomponent fibres from two polyester types.

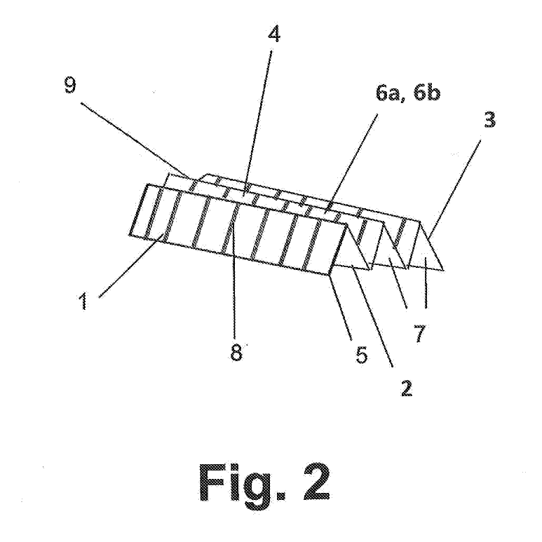

FIG. 2 shows the filter element according to another embodiment of the disclosure.

The layers 2, 3 of the main body 1 are pleated. The layers 2, 3 forming the main body 1 have grooves 8. The main body 1 includes the coating 6a or the diaphragm 6b and has pleating, namely folds 7. Furthermore, the grooves 8 are provided which extend substantially transversely with respect to fold tips 9.

The grooves 8 are formed in the main body 1 and in the coating 6a or the diaphragm 6b.

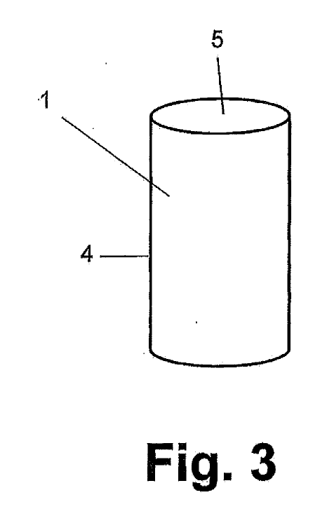

FIG. 3 shows the filter element configured as a filter tube.

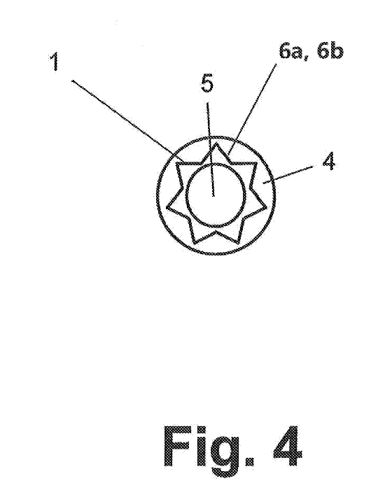

FIG. 4 shows the filter element configured as a filter cartridge, namely as a star filter with the main body 1 which is folded in a star-shaped manner and/or the coating 6 which is folded in a star-shaped manner.

In relation to the filter media, the layers 2, 3, the coating 6a or the diaphragm 6b, and the filter elements which are shown in FIGS. 2 to 4 exhibit the same construction as the filter element according to FIGS. 1A and 1B. The filter tube and the filter cartridge can likewise have the grooves 8.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A method of using a filter element comprising the steps of:
providing a filter element including a main body and at least one of a diaphragm and a coating having a plurality of nanofibers, the main body formed from at least one filter medium layer and having an inflow side and an outflow side, the at least one of the diaphragm and the coating disposed on the inflow side of the main body, wherein the at least one of the diaphragm and the coating is fine-porous and regenerable, and is configured to accumulate a dust cake on a surface of the filter element, wherein the dust cake is removable by one of a flushing air and a vibration; and
filtering incoming air to a cabin of a vehicle subjected to elevated dust loading with the filter element.

2. The method according to claim 1, further comprising a step of regenerating the filter element.

3. The method according to claim 1, wherein the air of the cabin of the vehicle has a dust concentration in a range of about 2 mg/m³ to about 5 g/m³.

4. The method according to claim 1, wherein the air of the cabin of the vehicle has a dust concentration in a range of about 5 mg/m³ to about 5 g/m³.

5. The method according to claim 1, wherein the air of the cabin of the vehicle has a dust concentration in a range of about 500 mg/m³ to about 5 g/m³.

6. The method according to claim 1, wherein the vehicle is one of a lorry, a construction machine, a compactor, a tracked vehicle, a road mill, a bulldozer, a dumper, a tracked backhoe, a grader, a digger, an excavator, a crane, a harvester, an agricultural machine, a combine harvester, a chipper, a tractor, a self-propelled sprayer, and a forestry vehicle.

7. A method of using a filter element comprising the steps of:
providing a filter element including a main body formed from at least one filter medium layer, the main body having an inflow side and an outflow side, the at least one filter medium layer is one of pleated and grooved;
providing the inflow side of the main body with one of a diaphragm and a coating having a plurality of nanofibers, wherein the at least one of the diaphragm and the coating is fine-porous and regenerable, and is configured to accumulate a dust cake on a surface of the filter element, wherein the dust cake is removable by one of a flushing air and a vibration;
filtering dust from incoming air to a cabin of a vehicle subjected to elevated dust loading having a dust concentration one of greater than and equal to 2 mg/m³ with the filter element; and
regenerating the filter element by the one of the flushing air and the vibration.
